(19) United States
(12) Patent Application Publication
(10) Pub. No.: US 2002/0139232 A1
(43) Pub. Date: Oct. 3, 2002

(54) Motor-driven eyeleting machine

(76) Inventor: Liang-Ching Hsu, Taipei Hsien (TW)

Correspondence Address: Keith Kline, PRO-TECHTOR INTERNATIONAL SERVICES, 20775 Norada Court, Saratoga, CA, 95070-3018, US

(21) Appl. No.: 09/819,525

(22) Filed: Mar. 27, 2001

(51) Int. Cl. B26F 1/04; B26D 5/16

(52) U.S. Cl. 83/549; 83/618; 83/628

(57) ABSTRACT

A motor-driven eyeleting machine includes two end eyeleting rod holders and two middle eyeleting rod holders respectively holding a respective eyeleting rod at one side of a revolving axle, two end cam wheels fixedly mounted on the revolving axle and rotated with the revolving axle to reciprocate the eyeleting rods in the end eyeleting rod holders respectively, two middle cam wheels respectively mounted on the revolving axle and adapted to reciprocate the eyeleting rods in the middle eyeleting rod holders selectively, and a shifter coupled to the middle cam wheels and shifted between two positions to alternatively set one middle cam wheel in the working position and the other middle cam wheel in the idle position.

### BACKGROUND OF THE INVENTION

The present invention relates to eyeleting machines and, more specifically, to a motor-driven eyeleting machine.

A motor-driven eyeleting machine is known comprising a base frame, two eyeleting rod holders respectively mounted on the base frame at two distal ends, two eyeleting rods respectively mounted in the eyeleting rod holders, two springs respectively mounted in the eyeleting rod holders to hold the eyeleting rods in position, two supports mounted on the base frame corresponding to the eyelet rod holders, a revolving axle supported on the supports, a motor mounted on the base frame at one side, a transmission gear train driven by the motor to rotate the revolving axle, two cam wheels fixedly mounted on the revolving axle and adapted to reciprocate the eyeleting rods in the eyeleting rod holders, and two guide blocks fixedly mounted on the base frame at a bottom side corresponding to the eyeleting rod holders and adapted to guide reciprocating movement of the eyeleting rods. This structure of motor-driven eyeleting machine is functional, however it can only punch two eyelets on the inserted paper. Further, because only two supports are provided to support the revolving axle, the revolving axle tends to vibrate during its rotary motion, resulting in short service life.

### SUMMARY OF THE INVENTION

The present invention has been accomplished to provide a motor-driven eyeleting machine, which eliminates the aforesaid drawbacks. According to one aspect of the present invention, the motor-driven eyeleting machine comprises two end eyeleting rod holders and two middle eyeleting rod holders respectively holding a respective eyeleting rod at one side of a revolving axle, two end cam wheels fixedly mounted on the revolving axle and rotated with the revolving axle to reciprocate the eyeleting rods in the end eyeleting rod holders respectively, two middle cam wheels respectively mounted on the revolving axle and adapted to reciprocate the eyeleting rods in the middle eyeleting rod holders selectively, and a shifter coupled to the middle cam wheels and shifted between two positions to alternatively set one middle cam wheel in the working position and the other middle cam wheel in the idle position. According to another aspect of the present invention, multiple supports are mounted on the base frame corresponding to the eyeleting rod holders to support the revolving axle. Because multiple supports are provided to support the revolving axle, the rotation of the revolving axle is smooth and stable. Therefore, the service life of the revolving axle is prolonged. Further, because multiple supports are provided to support the revolving axle, the revolving axle can be made of a rod member of small diameter.

### BRIEF DESCRIPTION OF THE DRAWINGS

FIG. 1 is a perspective view of a motor-driven eyeleting machine according to the present invention (the external cover shell removed).

FIG. 2 is an exploded view of the motor-driven eyeleting machine shown in FIG. 1.

FIG. 3 is a schematic drawing show the action of the eyeleting rod according to the present invention.

FIG. 4 is side view of the present invention showing the motor-driven eyeleting machine operated (I).

FIG. 5 is a side view of the present invention showing the motor-driven eyeleting machine operated (II).

FIG. 6 illustrates the outer appearance of the motor-driven eyeleting machine according to the present invention.

### DETAILED DESCRIPTION OF THE PREFERRED EMBODIMENT

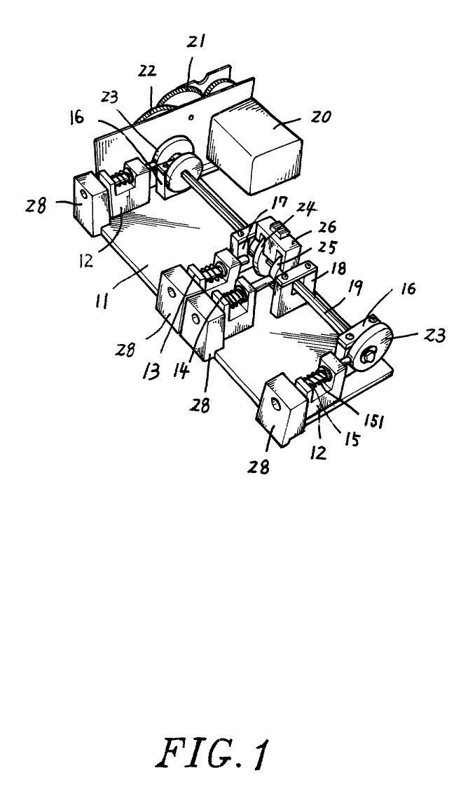

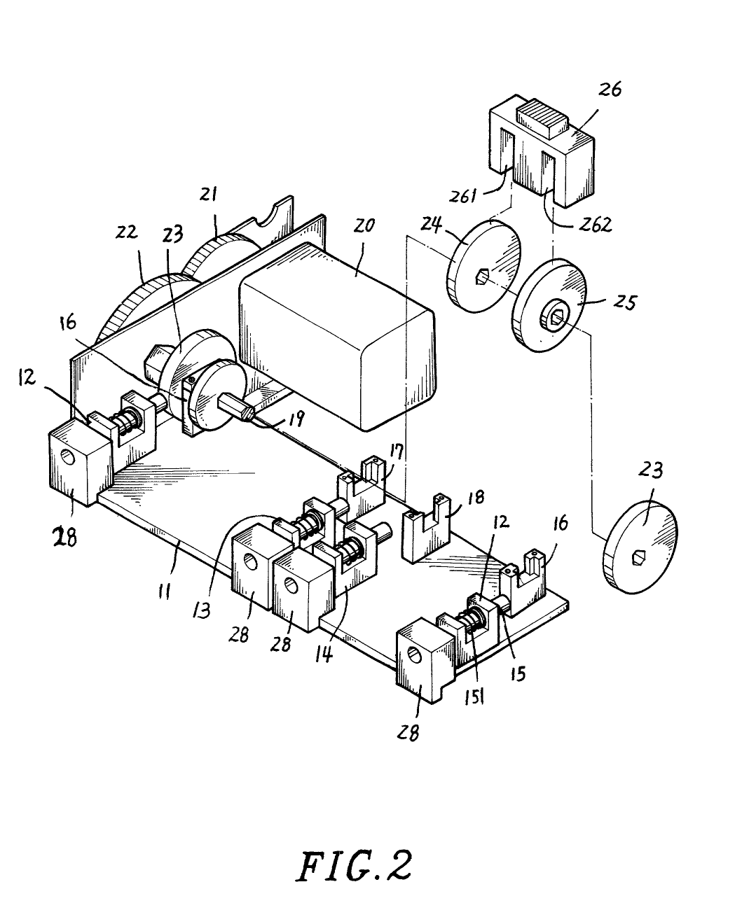

Referring to FIGS. 1 and 2, a motor-driven eyeleting machine is shown comprising a base frame 11, two first eyeleting rod holders 12 respectively mounted on the base frame 11 at two distal ends, a second eyeleting rod holder 13 and a third eyeleting rod holder 14 mounted on the base frame 11 on the middle and arranged in parallel, a plurality of eyeleting rods 15 respectively mounted in the eyeleting rod holders 12, 13 and 14, a plurality of springs 151 respectively mounted in the eyeleting rod holders 12, 13 and 14 to hold the eyeleting rods 15 in one position, namely, the upper limit position, a plurality of supports 16, 17 and 18 mounted on the base frame 11 corresponding to the eyeleting rod holders 12, 13 and 14, a revolving axle 19 supported on the supports 16, 17 and 18, a motor 20 mounted on the base frame 11 at one side, a transmission gear train 21 and 22 driven by the motor 20 to rotate the revolving axle 19, two first cam wheels 23 fixedly mounted on the revolving axle 19 and respectively disposed in contact with the eyeleting rods 15 in the first eyeleting rod holders 12, a plurality of guide blocks 28 fixedly mounted on the base frame 11 at the bottom side corresponding to the eyeleting rod holders 12, 13 and 14 and adapted to guide reciprocating movement of the eyeleting rods 15, a second cam wheel 24 and a third cam wheel 25 respectively mounted on the revolving axle 19 for synchronous rotation with the revolving axle 19, and a shifter 26 extended out of the shell of the eyeleting machine and adapted to shift the second cam wheel 24 and the third cam wheel 25 on the revolving axle 19 between the operative position and the non-operative position. The shifter 26 comprises two bottom slots 261 and 262, which receive the second cam wheel 24 and the third cam wheel 25 respectively.

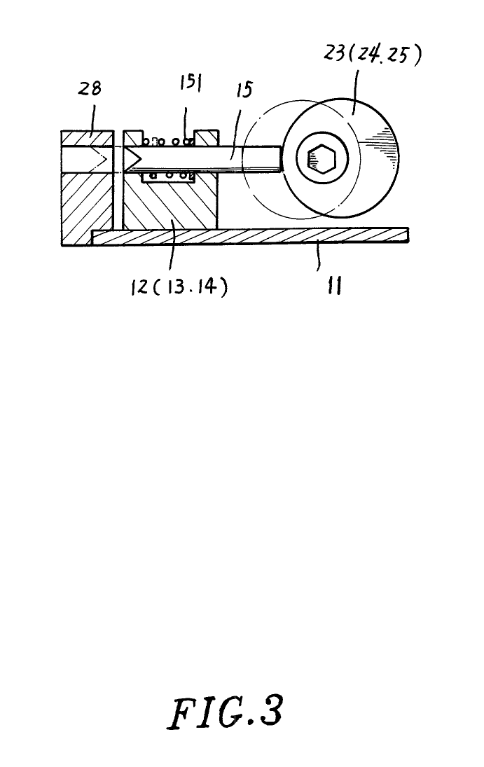

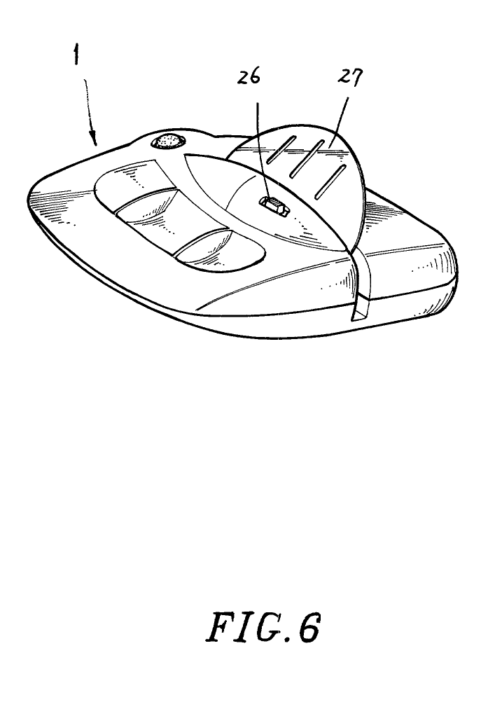

Referring to FIG. 6, paper is inserted into the gaps between the eyeleting rod holders 12, 13 and 14 and the guide blocks 28. When the motor 20 is started, the cam wheels 23, 24 and 25 are rotated to reciprocate the eyeleting rods 15, achieving an eyeleting action (see also FIG. 3). By means of moving the shifter 26 to shift the second cam wheel 24 and the third cam wheel 25 relative to the second eyeleting rod holder 13 and the third eyeleting rod holder 14, a two-eyelet or three-eyelet punching action is selectively achieved.

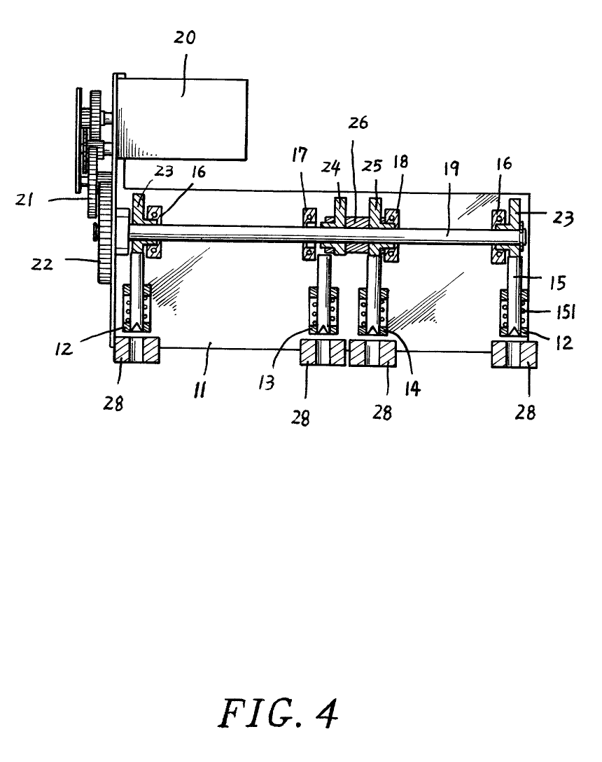

Referring to FIG. 4, when shifting the shifter 26 rightwards, the third cam wheel 25 is forced into contact with the eyeleting rod 15 in the third eyeleting rod holder 14, and the second cam wheel 24 is spaced from the eyeleting rod 15 in the second eyeleting rod holder 13, thus the eyeleting rods 15 on one first eyeleting rod holder 12 and the third eyeleting rod holder 14 are driven through the inserted paper to punch two eyelets on the inserted paper.

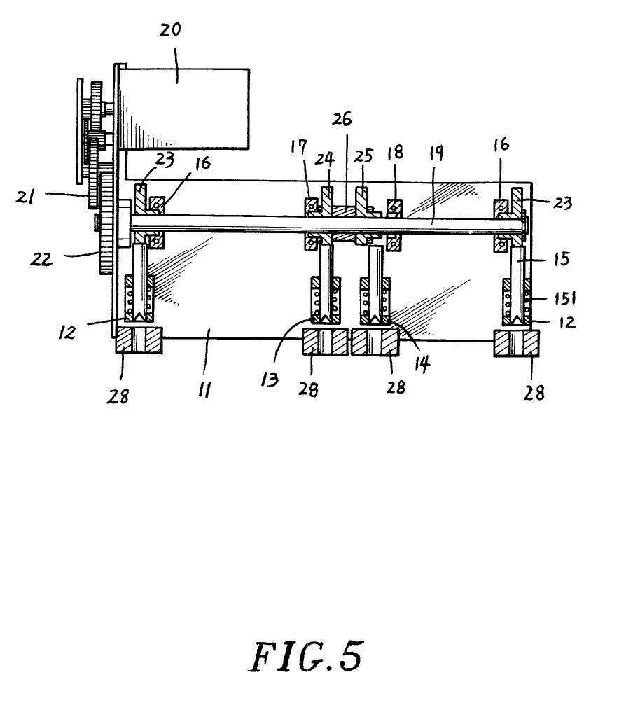

Referring to FIG. 5, when shifting the shifter 26 leftwards, the second cam wheel 24 is forced into contact with the top end of the eyeleting rod 15 in the second eyeleting rod holder 13, and the third cam wheel 25 is spaced from the eyeleting rod 15 in the third eyeleting rod holder 14, thus the eyeleting rods 15 on the first eyeleting rod holders 12 and the second eyeleting rod holder 13 are driven through the inserted paper to punch three eyelets on the inserted paper.

A prototype of motor-driven eyeleting machine has been constructed with the features of FIGS. 1˜6. The motor-driven eyeleting machine functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A motor-driven eyeleting machine comprising a base frame, two first eyeleting rod holders respectively mounted on said base frame at two distal ends, a second eyeleting rod holder and a third eyeleting rod holder mounted on said base frame on the middle and arranged in parallel, a plurality of eyeleting rods respectively mounted in said eyeleting rod holders, a plurality of springs respectively mounted in said eyeleting rod holders to hold the eyeleting rods in position, a plurality of supports mounted on said base frame corresponding to said eyeleting rod holders, a revolving axle supported on said supports, a motor mounted on said base frame at one side, a transmission gear train driven by said motor to rotate said revolving axle, two first cam wheels fixedly mounted on said revolving axle and adapted to reciprocate the eyeleting rods in said first eyeleting rod holders, a plurality of guide blocks fixedly mounted on said base frame at a bottom side corresponding to said eyeleting rod holders and adapted to guide reciprocating movement of said eyeleting rods, a second cam wheel mounted on said revolving axle and adapted to reciprocate the eyeleting rod in said second eyeleting rod holder, a third cam wheel mounted on said revolving axle and adapted to reciprocate the eyeleting rod in said third eyeleting rod holder, wherein a shifter is provided and adapted to shift said second cam wheel and said third cam wheel on said revolving axle between a first position where said second cam wheel is disposed in contact with the eyeleting rod in said second eyeleting rod holder for enabling the eyeleting rod in said second eyeleting rod holder to be reciprocated upon rotary motion of said revolving axle and said third cam wheel is spaced from the eyeleting rod in said third eyeleting rod holder to run idle upon rotary motion of said revolving axle, and a second position where said third cam wheel is disposed in contact with the eyeleting rod in said third eyeleting rod holder for enabling the eyeleting rod in said third eyeleting rod holder to be reciprocated upon rotary motion of said revolving axle and said second cam wheel is spaced from the eyeleting rod in said second eyeleting rod holder to run idle upon rotary motion of said revolving axle.

2. The motor-driven eyeleting machine of claim 1 wherein said shift has a part extended out of an outer shell of the motor-driven eyeleting machine.
